(19) United States
(12) Patent Application Publication
(10) Pub. No.: US 2007/0026239 A1
(43) Pub. Date: Feb. 1, 2007

(54) Functionalization of yarn and textile products

(75) Inventors: Hans Sigrist, Kernenried (CH); Francois Crevoisier, Cressier (CH); Hui Chai Gao, Neuchatel (CH); Mario Francesco Billia, Munchwilen (CH); Paul Raschle, St-Gallen (CH); Arie Bruinink, Effretikon (CH)

Correspondence Address: PROSKAUER ROSE LLP, 1001 PENNSYLVANIA AVE, N.W.,, SUITE 400 SOUTH, WASHINGTON, DC, 20004, US

(73) Assignee: CSEM Centre Suisse D-Electronique et de Microtechique SA, Neuchatel (CH)

(21) Appl. No.: 10/569,510

(22) PCT Filed: Aug. 26, 2004
(86) PCT No.: PCT/IB04/02962

§ 371 Date: Jul. 24, 2006

(30) Foreign Application Priority Data
Aug. 26, 2003 (GB) 0319929.6

(51) Int. Cl. B32B 17/06

(52) U.S. Cl. 428/429

(57) ABSTRACT

Methods of chemical and biochemical functionalization of yarn and textile products are described. A yarn or textile product is contacted with a linker molecule comprising two or more photochemically activatable chemical groups and a non-linker molecule having a desired property. Photochemical activation of the chemical groups causes covalent attachment of the non-linker molecule to the yarn or textile product by means of the linker molecule in a single step. The methods are particularly useful for immobilization to yarn or textile of biomolecules that are susceptible to denaturation. Use of linker molecules derived from proteins or polysaccharides further minimizes denaturation of the biomolecule.

### FIELD OF THE INVENTION

This invention relates to the chemical and biochemical functionalization of yarn and textile products.

### BACKGROUND OF THE INVENTION

Advanced textile technology focuses on integrating desired non-textile functions in the production steps such as yarn spinning, yarn finishing, post-weaving textile treatment and cloth treatment. However, most current yarn and textile production processes are not compatible with requirements implied by biological components such as enzymes and protein or carbohydrates. Therefore, the addition of new bio-based functions to textile materials, in particular textile functionalization with biologically active substances, is difficult to attain. Biologically active agents used to date for textile functionalization are preferably inorganic or organic in nature. Inorganic and organic materials generally conform with yarn and textile production conditions.

A representative example of an inorganic, biologically active agent is the inclusion of metallic material in textiles. The antibacterial activity of metals such as silver, copper, mercury and zinc is well documented. In contrast to antibiotics, bacteria do not acquire resistance to these bactericidal agents. Silver is generally a safe and effective antimicrobial metal. Silver ions function in adversely affecting cellular metabolism to inhibit bacterial cell growth. When absorbed into bacterial cells, silver ions suppress respiration, basal metabolism of the electron transport system, and transport of nutrients through microbial cell membranes. Silver ions also inhibit bacterial growth by producing active oxygen on the surface of silver powder and silver-plated articles.

U.S. Pat. No. 6,379,712 discloses a procedure for the encapsulation of metallic nanoparticles in a plant extract and documents widespread antimicrobial activity of the product. U.S. Pat. No. 5.709,870 discloses a silver containing antimicrobial agent comprising a silver salt of carboxymethylcellulose and having a degree of substitution of carboxymethyl groups of not less than 0.4. Japanese patent No. 3-136649 discloses an antibacterial cloth to be used for washing the udders of milk cows. The silver ions from silver nitrate were crosslinked with polyacrylonitirile. The cloth had anti-bacterial activity to six different types of bacteria including streptococcus and staphyloccus.

Quaternary ammonium salts are examples of organic molecules that affect microbial growth and proliferation. Either as low molecular weight components or as polymers, quaternary ammonium salts have been included in yarns and textile products and antimicrobial activity of this class of agents has been demonstrated. U.S. Pat. No. 6,436,419 teaches that bonding of “quats” on a substrate such as textiles results in a durable, safe, antibacterial treatment. Moreover, U.S. Pat. No. 6,306,835 discloses that 3-trimethylammonium-2-hydroxypropyl-N-chitosan, a quaternary ammonium derivative of chitosan, exhibits antimicrobial activity at low concentrations.

Lysozyme is a muraminidase with basic character which is widely distributed in nature. Its antibacterial activity is strongly related to its catalytic properties that affect Gram-positive bacteria. It has further been suggested that lysozyme in its dimeric form exhibits bacteriostatic properties towards both Gram-positive and Gram-negative bacteria. Antimicrobial activity was retained with a lysozyme-dextran conjugate in which the lysozyme appears to be linked to dextran at the reducing end of the polysaccharide (S. Nakamura, A. Kato, K. Kobayashi. J. Agric. Food. Chem. 1991, 39, 647-650).

Many natural or synthetic yarns and textile products do not have physical or chemical properties that allow modifications to be made. Synthetic yarn endures harsh chemical treatment (with regard to temperature and solvents) during the spinning process or during chemical post-spinning treatment. Post-spinning processes are for instance i) dyeing and associated curing of dyed yarns, ii) post-spinning fibre texturation, iii) cleaning of natural and synthetic yarns and textiles. Moreover, most of these processes are batch processes and are not locally applicable.

Because most yarn and textile production and dying processes are carried out at high temperatures there is limited opportunity to introduce biochemical functions to these materials. High temperatures disrupt the correct folding of biomolecules that is required for them to catalyse biochemical reactions or take part in biospecific intermolecular binding events. The choice and chemical nature of the linker may thus be decisive for successful immobilization of (catalytically) active or target binding biomolecules to yarn and textile-based materials.

U.S. Pat No. 4,496,363 describes preparation of antimicrobial fabrics by aminoalkylsilylation of a base fabric which has free hydroxyl groups (or which has been treated to provide free hydroxyl groups), reaction of the terminal amino group of the aminoalkylsilylated fabric with one terminus of a bifunctional reagent, then reaction of the other terminus of the bifunctional reagent with an amino group of an antimicrobial agent. Preparation of antimicrobial fabrics in this way has several disadvantages. The base fabric must have, or be provided with hydroxyl groups, and the base fibres must be chemically modified by the introduction of an aminoalkylsilane group to allow attachment of the bifunctional reagent. The choice of bifunctional reagents is limited to those that are capable of reacting with the aminoalkylsilane and the antimocrobial agent. The process comprises at least three separate reaction steps (four steps are required where the base fabric does not comprise free hydroxyl groups).

U.S. patent application Ser. No. 2003/0013369 describes reaction of textiles with nanoparticles comprising a polymeric encapsulator that surrounds or contains a payload, thereby permanently attaching the payload to the textile. The nanoparticles are formed by polymerizing the polymeric encapsulator around the agent or payload, or absorbing the payload into the polymeric network of the polymeric encapsulator. Whilst a variety of different payloads can be immobilized by such methods, they are complicated by the need to form the polymeric encapsulators, and then to immobilize the payload to the encapsulators, and the encapsulators to the textile. The methods are also limited to textiles that can be reacted with the nanoparticles formed. U.S. Pat. No. 4,464,468 describes immobilization of a proteolytic enzyme to fabric. The fabric is first soaked in a solution of a hydrolytic enzyme and an inactive protein, then in a solution of a bridging agent (glutaraldehyde is the example given). Only biomolecules that react with the bridging agent can be immobilized. Immobilisation of the enzyme to the fabric appears to be by adsorption rather than by covalent attachment.

Thus, prior art methods for immobilization of biomolecules to yarn or textile products suffer from one or more of the following disadvantages: they are complex and often involve several steps, they can only be applied to a limited number of yarns or textiles and biomolecules, the activity of the immobilized biomolecules is often reduced, the biomolecule is not permanently immobilized to the yarn or textile.

It is desired to provide a simple process for covalent functionalisation of yarn and textile products.

It is also desired to provide a process for effectively immobilizing biomolecules on yarn and textile products which allows the biomolecules to retain, or substantially retain, their biological activity.

It is also desired to provide a process that allows unrestricted covalent attachment of low and high molecular weight substances to yarns and textiles.

It is also desired to provide controlled release of immobilized species from functionalized yarns and textile products.

It is also desired to provide a yarn or textile product with antibiotic properties.

### SUMMARY OF THE INVENTION

According to a first aspect of the invention there is provided a method of providing a yarn or textile product with a desired property which comprises:
contacting a linker molecule comprising two or more activatable chemical groups with a yarn or textile product, and a non-linker molecule having a desired property;
activating the activatable chemical groups of the linker molecule to cause covalent attachment of the linker molecule to the yarn or textile product and the non-linker molecule, thereby attaching the non-linker molecule to the yarn or textile product by means of the linker molecule, and providing the yarn or textile product with the property of the non-linker molecule.

It will be appreciated that the linker molecule is not covalently attached to the yarn or textile product, or the non-linker molecule, until after the activatable chemical groups have been activated. Once activated, the chemical groups cause covalent attachment of the linker molecule to the yarn or textile product and the non-linker molecule.

The non-linker molecule may be a solvent, a synthetic or natural chemical, a synthetic or natural dye, a synthetic polymer, a biopolymer, a biomolecule, a biologically active molecule, a synthetic or natural vitamin or hormone, or any combination thereof. Examples of biomolecules include proteins (particularly enzymes, target-binding proteins, and glycoproteins), peptides, nucleic acids, carbohydrates, and lipids.

Preferably the non-linker molecule is an enzyme (such as lysozyme), a growth factor, an anti-microbial agent, an antibiotic, a fungicide, an agent capable of suppressing the proliferation of bacteria or fungi, or any combination thereof.

The linker molecule, the yarn or textile product, and the non-linker molecule may be contacted in any order. Preferably the linker molecule is contacted with the yarn or textile product before the non-linker molecule.

According to the first aspect of the invention there is also provided a yarn or textile product covalently attached, by means of a linker molecule, to a non-linker molecule having a desired property, thereby providing the yarn or textile product with the desired property.

There is further provided according to the first aspect of the invention a linker molecule comprising two or more activatable chemical groups to allow covalent attachment of the linker molecule to a yarn or textile product and a non-linker molecule having a desired property thereby attaching the non-linker molecule to the yarn or textile product by means of the linker molecule, and providing the yarn or textile product with the property of the non-linker molecule. An important advantage of methods of the first aspect of the invention is that once the linker molecule is in contact with the yarn or textile product and the non-linker molecule, the non-linker molecule can be covalently attached to the yarn or textile product in a single reaction step. This is achieved simply by activating the activatable chemical groups of the linker molecule. The term “activatable chemical group” is used herein to mean that the chemical group will not cause covalent attachment of the linker molecule to the yarn or textile product or the non-linker molecule until it has been activated. Activation of the chemical group (for example by photochemical or thermochemical activation) chemically converts the group into a reactive intermediate that reacts with the yarn or textile product, or with the non-linker molecule, thereby causing a covalent bond to be formed between the linker molecule and the yarn or textile product, or the non-linker molecule.

Preferably the linker molecule is multiply substituted with activatable chemical groups.

In preferred embodiments of the invention, activation of the activatable chemical groups chemically converts them into highly reactive intermediates. Examples of highly reactive intermediates are carbenes, nitrenes, and ketyl radicals. Carbenes cause insertion reactions in C—H, C—C, C═C, N—H, O—H and S—H bonds.

In preferred embodiments of the invention, the activatable chemical groups are activatable with actinic energy.

In particularly preferred embodiments of the invention, the activatable chemical groups are thermochemically or photochemically activatable.

Photochemically activatable groups are particularly preferred where the non-linker molecule is a biomolecule (such as a protein or a peptide) that is susceptible to denaturation (caused, for example, by high temperature). Photochemical activation of the photochemically activatable groups allows the biomolecule to be attached to the yarn or textile product under conditions that do not denature the biomolecule. A further advantage of photochemical activation is that the reaction time can be controlled.

When exposed to an appropriate energy source, a photoreactive group (i.e. a photochemically activatable group) undergoes a transition from an inactive state to a reactive intermediate capable of forming covalent bonds with appropriate materials or molecules. Such agents, in particular photolinker polymers that are multiply substituted with photoreactive groups, can be used for either attaching non-reactive compounds to a surface or for priming a relatively inert surface to render it reactive upon exposure to suitable actinic radiation.

Preferred photoactivatable chemical groups are diazirines, particularly aryldiazirines. These compounds are precursors for photogenerated carbenes. Other preferred photoactivatable chemical groups are members of the benzophenone family, benzophenone being the moiety that generates reactive intermediates. Benzophenones are precursors for photogenerated ketyl radicals. Further photoactivatable chemical groups include arylazides. Arylazides are precursors for photogenerated nitrenes. However, these are less preferred because they are less efficient and require difficult handling conditions.

In particularly preferred embodiments of the invention, activation of the activatable chemical groups of the linker molecule generates carbene intermediates. In such embodiments, each activatable chemical group is a precursor for a carbene intermediate. Carbene intermediates cause insertion reactions in C—H, C—C, C═C, N—H, O—H and S—H bonds. Thus, once generated, each carbene intermediate reacts with the yarn or textile product or with the non-linker molecule to form a covalent bond between the linker molecule and the yarn or textile product or the non-linker molecule.

The high reactivity of carbene intermediates means that the linker molecule can be covalently attached to almost any type of yarn or textile product, and non-linker molecule without the need to first modify the yarn or textile product or the non-linker molecule.

Modification of amino dextran with 3-(trifluoromethyl)-3-(m-isothiocyanophenyl) diazirine to form photolinker polymers is described in Example 1 below, and use of the photolinker polymers to immobilize alkaline phosphatase and lysozyme to textile is described in Examples 3, 4, and 6. Modification of BSA with 3-(trifluoromethyl-3-(m-aminophenyl)diazirine (TRIMID) to form a photolinker peptide, and use of the photolinker peptide to photoimmobilise streptavidin to a mictor-titre plate is described in EP 484472 (the content of which is incorporated herein by reference). Equivalent methods may be used for immobilization of non-linker molecules to yarn or textile products in accordance with the present invention. Use of biopolymers derivatized with latent reactive groups to covalently couple reagents to substrates is also described in U.S. Pat No. 5,563, 056 and DE 19818360.

For embodiments of the invention in which the non-linker molecule is not a biomolecule that is susceptible to denaturation, thermochemically activatable chemical groups may be used. Diazirines may be thermally activated to generate carbenes by heating to 75-120° C., preferably 80-110° C.

The linker molecule may further comprise one or more functional groups having a desired property different to the property of the non-linker molecule, so that covalent attachment of the linker molecule to the yarn or textile product additionally provides the yarn or textile product with the property of the, or each functional group.

According to a second aspect of the invention there is provided a method of providing a yarn or textile product with a desired property which comprises:
contacting a linker molecule comprising one or more activatable chemical groups, and one or more functional groups having a desired property, with a yarn or textile product;
activating the activatable chemical group or groups of the linker molecule to cause covalent attachment of the linker molecule to the yarn or textile product, thereby providing the yarn or textile product with the property of the functional group(s) of the linker molecule.

There is further provided according to the second aspect of the invention a yarn or textile product covalently attached to a linker molecule, the linker molecule comprising one or more functional groups having a desired property, thereby providing the yarn or textile product with the desired property.

There is also provided according to the second aspect of the invention a linker molecule comprising one or more activatable chemical groups to allow covalent attachment of the linker molecule to a yarn or textile product, and one or more functional groups having a desired property, so that covalent attachment of the linker molecule to the yarn or textile product provides the yarn or textile product with the property of the functional group(s) of the linker molecule.

Preferably the, or each functional group is a positively charged group at neutral pH (such as an amino group), a negatively charged group at neutral pH (such as a carboxyl group), a thiol group, or a dye such as a fluorescent dye.

Methods of the invention may further comprise contacting the yarn or textile product with metal ions to bind the metal ions to the yarn or textile product. The metal ions may bind to the yarn or textile product either directly, or via charges on the linker molecule or the non-linker molecule. If the, or each functional group of the linker molecule is negatively charged, preferably the yarn or textile product is contacted with positively charged metal ions, preferably silver ions, to bind the metal ions to the functional group or groups. Metal ions such as silver ions have antibacterial action. Thus, these embodiments allow the antibacterial action of metal ions to be combined with the desired property of the non-linker molecule.

Preferably the metal ions are contacted with the yarn or textile product before the linker molecule. In preferred embodiments in which the functional group(s) are negatively charged, the metal ions can bind to the linker molecule once it has been contacted with the yarn or textile product, thereby retarding their release from the yarn or textile product.

According to the invention, the linker molecule preferably comprises a natural or synthetic polymer, preferably a biopolymer. Particularly preferred linker molecules comprise a protein, peptide, or polysaccharide, or a dextran-based polymer.

Biomolecules (such as proteins or peptides) must be properly folded to retain their activity. Their 3-D structure must be intact even after they have been immobilized. Intramolecular and intermolecular hydrogen bonds are essential for sustaining 3-D structured domains in biomolecules, particularly in catalytically active enzymes, target-binding proteins and glycoproteins. Use of protein-based or polysaccharide-based linker polymers to functionalize textiles or yarns with biomolecules allows the immobilized biomolecules to retain their activity.

The polymer may be chemically derivatised to provide the polymer with one or more (preferably multiple) activatable chemical groups. Preparation of preferred dextran-based biopolymers derivatised with a diazirine (they are referred to as OptoDex A, OptoDex C) is described in Example 1 below. Derivatisation of BSA with TRIMID (a photochemically activatable chemical group) is described in EP 484472.

In particularly preferred embodiments of the invention the linker molecule comprises a cleavage site which is cleaved under predetermined conditions to release the non-linker molecule or functional group from the yarn or textile product. This allows controlled release of the non-linker molecule or functional group from the yarn or textile product. For example, the linker molecule may comprise a target for a hydrolytic enzyme to allow enzyme-induced, or biosystem-induced release of the non-linker molecule or functional group. The following are suitable examples:
i) the linker molecule comprises a substrate for an endoglycosidase, or an endopeptidase;
ii) the linker molecule is a dextran-based biopolymer which comprises a target for a dextranase;
iii) the linker molecule is a hyaluronic acid-based biopolymer which comprises a target for a hyaluronidase;
iv) the linker molecule is a protein-based polymer which comprises a target for a protease;
v) the linker molecule is a peptide-based polymer which comprises a target for an endopeptidase.

The term “textile product” is used herein to include any cloth or fabric, particularly any woven material. The term “yarn product” is used herein to include any spun thread. The textile product may be of natural or synthetic origin, a blend of synthetic yarns, or a blend of natural and synthetic yarns.

In some circumstances, it may be desirable to pre-treat the yarn or textile product to improve its wetting properties so that the linker molecule can adsorb to the surface of the yarn or textile product. For example, commercial synthetic polyester yarn has low water adsorption and wetting properties and so may be pre-treated with oxygen plasma.

There is further provided according to the invention use of a linker molecule of the invention to covalently attach a non-linker molecule having a desired property and/or a functional group having a different desired property to a yarn or textile product, thereby providing the yarn or textile product with the desired property or properties.

There is also provided according to the invention a composition comprising a yarn or textile product, a linker molecule of the invention, and optionally a non-linker molecule.

According to a third aspect of the invention, it may be desired to covalently attach the linker molecule to the yarn or textile product before the non-linker molecule.

In accordance with the third aspect of the invention there is provided a method of providing a yarn or textile product with a desired property which comprises:
contacting a yarn or textile product that is covalently attached to a linker molecule with a non-linker molecule having a desired property, the linker molecule comprising one or more activatable chemical groups;
activating the activatable chemical group(s) of the linker molecule to cause covalent attachment of the non-linker molecule to the linker molecule and provide the yarn or textile product with the desired property.

There is also provided according to the third aspect of the invention a yarn or textile product that is covalently attached to a linker molecule, the linker molecule comprising one or more activatable chemical groups to allow covalent attachment of a non-linker molecule having a desired property to the linker molecule and thereby provide the yarn or textile product with the desired property.

According to a fourth aspect of the invention it may be desired to covalently attach the linker molecule to the non-linker molecule before the yarn or textile product.

In accordance with the fourth aspect of the invention there is provided a method of providing a yarn or textile product with a desired property which comprises:
contacting a yarn or textile product with a linker molecule comprising one or more activatable chemical groups, wherein the linker molecule is covalently attached to a non-linker molecule having a desired property;
activating the activatable chemical group(s) of the linker molecule to cause covalent attachment of the linker molecule to the yarn or textile product and provide the yarn or textile product with the desired property of the non-linker molecule.

There is further provided according to the fourth aspect of the invention a linker molecule comprising one or more activatable chemical groups to allow covalent attachment of the linker molecule to a yarn or textile product, wherein the linker molecule is covalently attached to a non-linker molecule having a desired property.

### DETAILED DESCRIPTION OF THE INVENTION

Use of linker molecules in accordance with the invention is one approach to overcome the limitations of current yarn, textile and cloth processing. In preferred embodiments of the invention the linker molecules are bound to a textile in a one-step process or in a sequential two-step process. In preferred embodiments, the linker molecules are multiply (preferably more than two) substituted polymeric chemicals. Preferably the substitutions are thermochemically or photochemically activatable chemical groups which allow, upon activation, the formation of covalent bonds with molecular species that are to be attached to materials or textile fibers. In comparison with current direct chemical derivatization of yarns and textile products by batch processing, linker polymers with addressable (i.e. activatable) chemical reactivity can add beneficial physical and chemical characteristics to a textile. Modification of yarn and textile using linker polymers allows the surface charge and/or surface polarity of the yarn or textile to be changed, and allows the possibility of secondary chemical modification of the yarn or textile (which may be thermochemical or photochemical).

The invention provides a generic process for covalent chemical functionalization of textile. Preferred embodiments of the invention relate to the use of linker polymers (i.e. linker molecules that comprise polymers). Use of linker polymers allows attachment of dyes, polymers, biomolecules, or inorganic materials to textile of any shape and dimension at any stage in manufacture of the textile. In preferred embodiments of the invention the linker polymers are multiply substituted with chemical functional groups. that convert to highly reactive intermediates when activated with actinic energy.

Preferred linker polymers for use according to the invention are derived from polysaccharides or proteins. Polar domains of proteins and, in particular, polysaccharides bind water molecules and thus provide chemical features for hydrogen bonding. Proteins or polysaccharides attached as linker polymers to yarn or textile material surfaces make these surfaces homogeneously hydrophilic, suppress non-specific adsorption of system components, and generate a high degree of biocompatibility.

Proteins (for example bovine serum albumin), can be multiply derivatized at epsilon amino groups of lysine residues with organic isothiocyanates (for example) or other amine derivatizing chemical crosslinkers. Any protein comprising more than two lysine amino acid residues may, therefore, be used as a protein-based linker polymer. This also includes synthetic polypeptides or genetically engineered and recombinant proteins.

Depending on the use of the modified textile (i.e. the textile produced according to methods of the invention), it may be advantageous to utilize designed (i.e. engineered) protein-based linker polymers. For example, proteins engineered to have improved thermostability may be used. This may be advantageous where the modified textile will be exposed to high temperatures, and may improve the resistance of the modified textile or yarn to loss of the desired property of the non-linker molecule at these high temperatures. Alternatively or additionally, proteins that include amino acid sequences that are uniquely recognized and catalytically cleaved by specific proteases may be used if enzyme-induced release of the non-linker molecule (for example a bioactive species) is envisaged.

Another preferred type of linker molecule is based on polysaccharides, for example dextrans or hyaluronic acid (among many others). Dextran can be modified by chemically opening a defined number of glucose molecules constituting the polymer at vicinal hydroxyl groups. The aldehydes thereby generated are then further derivatized into amino groups to produce amino dextran which can be functionalized with amine reactive photoactive bifunctional crosslinkers. The size of the dextran molecule (i.e. its molecular weight) is not limiting. Any type of dextran or polyglycan may be used to produce photolinker polymers. The more glucose molecules that are derivatized in the linker molecule, the higher the probability of forming densely crosslinked polymers.

A similar strategy can be adopted to form linker polymers from hyaluronic acid. Acetylated amino sugars of the hyaluronic acid are chemically or enzymatically deacetylated to produce polysaccharide based polymers presenting reactive amino groups for thiocarbamoylation reactions, for example. The molecular weight or chain length of the hyaluronic acid is not limiting.

Endoglycosidases (such as dextranase, cellulase, glucanase or hyaluronidase), can be used to cleave a polysaccharide-based linker polymer either to tailor the molecular size of the starting material or to catalytically cleave immobilized molecular species effecting timed release. Analogously, sequence specific proteases (such as asparaginase, pectinase or protease (Aspergillus niger)), may be used to selectively cleave protein- or peptide-based linker polymers. Covalent and non-covalent assemblies of enzymes and target-binding proteins with polysaccharides or proteins show improved long-term stability.

Other preferred embodiments of the invention relate to the synthesis and use of linker polymers that carry functional groups, in addition to photoactivatable chemical groups. Limited substitution of hetero-bifunctional photocrosslinkers leads to a linker polymer with free amino groups. A particularly preferred embodiment is called OptoDex A (Opto for optically activatable, Dex for dextran and A for amine groups). Treatment of the amino groups in a second reaction with an anhydride (such as glutaranhydride) provides a linker polymer with free carboxyl groups. Such derivatives are negatively charged at neutral pH. The product is called OptoDex C (Opto for optical activatable, Dex for dextran and C for available carboxyl groups).

In analogy to the negatively charged linker polymer, a photoactivatable linker polymer can been synthesized by derivatization of OptoDex A with an activated fluorophore such as a N-hydroxysuccinimide ester of the cyanine dye Cy3 or Cy5. Products of such modifications are fluorescent photoactivatable linker polymers, the fluorescent properties of which are in accordance with the parent fluorophores Cy3 and Cy5 respectively. Cy3-OptoDex or Cy5-OptoDex provide examples of linker polymers that can be used to covalently attached dyes (here fluorescent dyes) to yarns and textiles. The covalent link between the yarn or textile and the linker polymer is effected by irradiation with light.

Post-process carbene mediated functionalization of yarn and textile is effective in attaching bioactive reagents, such as antimicrobial agents including low molecular substances, to yarn and textile. In preferred embodiments of the invention, chemically derivatized biopolymers provide carbene generating linker polymers for post-process treatment of yarn and textile. Thus, in preferred embodiments of the invention the activatable chemical group or groups of the linker polymer are precursors for carbene intermediates. As carbenes form covalent bonds with all materials except metals, all yarn and textile materials except metallic wires can be functionalized by the linker polymer. Examples include synthetic yarns (such as polyamide, polyester, mylar, and others) natural fibers and textiles (such as cotton and silk among others), blended yarns and textile blend products. Textile functionalization can be carried out at any step in textile processing.

Other preferred embodiments of the invention concern application of methods of the invention for dyeing yarn and textile, and for physico-chemical functionalization of yarn and textile. In preferred embodiments of the invention, textile or yarn can be dyed by a procedure as described in Examples 1 and 2 below (in which the linker polymer is first covalently linked to the dye, then contacted with the textile or yarn, before the linker polymer is crosslinked to the textile or yarn), or by applying a mixture of the linker polymer and the dye to the textile or yarn and then crosslinking the linker polymer to the yarn or textile and the dye. The dye molecules are covalently bound to the textile samples upon activation of the latent carbene generating groups with light or at elevated temperatures (75-120° C., preferably 80-110° C.).

Mere attachment of linker polymers to yarn or textile can change the physical properties of the yarn or textile depending on the characteristics of the linker polymer chosen. For example, the surface charge of yarns can be deliberately adjusted by simply attaching linker polymers carrying either amino groups (positively charged at neutral pH) or carboxyl groups (negatively charged at neutral pH).

Particularly preferred embodiments of the invention relate to covalent attachment of biomolecules to textiles or yarns. There is no limitation with respect to the type or size of biomolecules that can be immobilized. However, small molecules may require use of linker polymers with a high degree of substitution with photoactivatable groups to increase the chances of covalent attachment of the linker polymer to the biomolecule. Examples 3 and 4 describe immobilization of the enzymes alkaline phosphatase and lysozyme, respectively. Lysozyme is a muraminidase which is widely distributed in nature. Its antibacterial activity is related to its catalytic properties by breaking the cell wall components of Gram-positive bacteria. In its polymeric state or as a dextran conjugate, lysozyme has antimicrobial activity for both Gram-negative and Gram-positive bacteria. Example 4, therefore, provides an example of generation of textile with antibiotic properties.

Methods of the invention in which the linker molecule comprises one or more photochemically activatable chemical groups can be used to provide a textile product with patterned deposition of colour or specific biological reagents.

In other preferred embodiments of the invention, the linker polymer comprises a cleavage site which is cleaved under predetermined conditions to release the non-liker molecule from the yarn or textile product. Example 5 below describes immobilization of lysozyme to textile using a dextran-based linker polymer. The linker polymer is accessible to the enzyme dextranase. The hydrolytic action of this enzyme releases the immoblized lysozyme. The example also shows that the linker polymer is responsible for retention of lysozyme on the textile sample.

According to other preferred embodiments of the invention polymer mediated immobilization of bioactive substances is combined with the antibacterial action of metals (such as silver and others). For example, metallic silver may be deposited on woven textile, followed by coating with the linker polymer OptoDex. In one preferred embodiment, a linker polymer providing negative charges (such as OptoDex C) may be selected to allow the binding and retarded release of bioactive Ag⁺ ions (as liberated from metallic silver in biological environments). In a further preferred embodiment silver (antimicrobial) and linker polymer coated textile is combined with a second antibacterial agent (such as lysozyme) in order to increase the antimicrobial effect of the modified textile and broaden the scope of antimicrobial activity of the product. Such an embodiment is described in Example 6.

Methods and products of the invention have wide application. Functionalization of yarn and textile is of use in dyeing of fabrics and cloths. Linker polymers with photoactive groups provide the basis for local attachment of bioactive agents or dyes to yarn or textile products. Linker polymer mediated immobilization of antimicrobial and antibacterial agent produces yarn and textile products with desired properties that can be used in medicine and specifically in the treatment of wounds.

Various aspects of the invention are defined in the following paragraphs:
1. Yarn, textile and textile products post-process functionalised by covalent bonding linker molecules, preferably carbene generating linker polymers, and non-linker molecular species, whereby the combination of the linker molecule and non-linker molecular species generate new physical, chemical properties of the base material and tailored biochemical interactions with biosystems.
2. Textiles and textile products as described in paragraph 1 whereby the textile material is of natural or synthetic origin, blends synthetic yarns, blends of natural and synthetic yarns, and textile products made of blended yarns.
3. Yarn, textile and textile products as described in paragraphs 1 and 2, wherein the linker molecules are natural or synthetic polymers multiple substituted with thermochemically or photochemically activatable chemical functions.
4. Yam, textile and textile products as described in paragraphs 1 to 3, wherein the linker molecules are proteins, peptides or polysaccharides and the generated chemically reactive functions are carbene intermediates.
5. Yam, textile and textile products as described in paragraphs 1 to 4 wherein the non-linker molecular species are solvents, synthetic or natural chemicals, synthetic polymers, biopolymers, biomolecules or combinations thereof.
6. Yam, textile and textile products as described in paragraphs 1 to 5, wherein the non-linker molecular species are synthetic or natural dyes.
7. Yarn, textile and textile products as described in paragraphs 1 to 6 with linker molecules and biologically active molecules that actively interact with biological systems by effecting activation, regulation or inhibition of biosystem components.
8. Yarn, textile and textile products as described in paragraphs 1 to 7, wherein the non-linker molecular species are enzymes, growth factors, anti-microbial agents, antibiotics, fungicides or combinations thereof.
9. Yarn, textiles and textile products as described in paragraphs 1 to 8 whereby the photolinker polymer is a dextran-based photolinker polymer and the biologically active molecule is lysozyme.
10. Yarn, textile and textile products as described in paragraphs 1 to 9, wherein the non-linker molecular species are synthetic or natural vitamins or hormones.
11. Yarn, textile and textile products as described in paragraphs 1 to 10, whereby the linker molecules are targets of hydrolytic enzymes allowing enzyme-induced, or biosystem-induced release of biologically active non-linker molecules.
12. Textiles and textile products as described in paragraphs 1 to 11 whereby the linker molecule is a substrate for endoglycosidases, or a substrate for endopeptidases.
13. Textiles and textile products as described in paragraphs 1 to 12 whereby the linker molecule is a dextran-based biopolymer and the hydrolase is a dextranase.
14. Textiles and textile products as described in paragraphs 1 to 12 whereby the linker molecule is a hyaluronic acid based biopolymer and the hydrolase is a hyaluronidase.
15. Textiles and textile products as described in paragraphs 1 to 12 whereby the linker molecule is a protein- or peptide-based polymer and the hydrolase is a protease or an endopeptidase, respectively.
16. Medical and sanitary textile, textile products and implants that are engineered with biologically active substances as described in paragraphs 1 to 15 whereof bioactive non-linker molecular species are released by hydrolases by catalytically cleaving the linker polymer.
17. Functional textile engineered according to paragraph 1 to 16 whereby the biologically active molecules suppress the proliferation of bacteria or fungi.
18. Yarn, textile and textile products as described in paragraphs 1 to 5 by linker molecules, the addition of which alters the physical and chemical properties of the textile material.
19. Functionalized linker polymers consisting of a polymer as described in paragraph 3 and having additional secondary functional groups such as carboxyl-, amino-, or thiol functions, that allow, singular or in combination, timed release of bioactive molecules.
20. Yarn, textile and textile products as described in paragraphs 1 to 5 and paragraphs 18 and 19, wherein the linker molecule is a biopolymer with negative charges and the bioactive agents are positive charged metal ions (for example as released from sputtered metallic deposits).
21. Yarn, textile and textile products as described in paragraphs 1 to 5 and paragraphs 18 and 20, wherein the linker molecule is a biopolymer with negative charges and the bioactive agents are positive charged silver ions (for example as released from sputtered silver deposits).
22. Yarn, textile and textile products wherein the linker molecule is a negatively charged photoactive biopolymer as described in paragraphs 1 to 5 and paragraphs 18 and 20, whereby the biologically active non-linker molecular species is lysozyme and both lysozyme and metal ions are used in combination to inhibit bacterial proliferation.

This invention provides generic procedures for the functionalization of almost any type of yarn or textile (natural or synthetic) with any type of molecular species (including biologically active substances). In preferred embodiments of the invention, textile or yarn is post-process treated with linker polymers able to generate carbenes. The chemical, physical and biochemical properties of target yarns and textiles can be selectively altered using such carbene generating linker polymers. Such treatment may alter the bioresponse of textile products, or introduce novel bioactivity features to textile products. Post-process carbene mediated functionalization of yarn and textile is effective in attaching low molecular components by linker polymer mediated immobilization. Appropriate choice of the linker polymer in conjunction with specific catalytic cleavage of the linker polymer enables controlled release of bioactive chemical species.

Although the present invention has been described in considerable detail with reference to certain preferred versions thereof, other versions are possible. For example instead of using yarn and textile products as material substrate, the substrate may be of solid materials such as for instance metal oxides on metal or glass surfaces, on organic polymers and many other material substrates. Therefore, the spirit and scope of the appended paragraphs should not be limited to the description of the preferred versions contained herein.

Preferred embodiments of the invention are now described in the following examples with reference to the accompanying drawings in which:

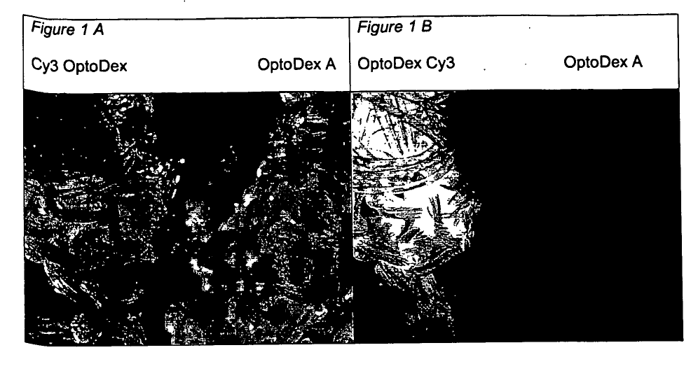

FIG. 1 shows the optical microscopy image (FIG. 1A) and fluorescence microscopy image (FIG. 1B) of polyester textile treated with the linker polymer (OptoDex) or dye-labeled (fluorescent) Cy3-OptoDex.

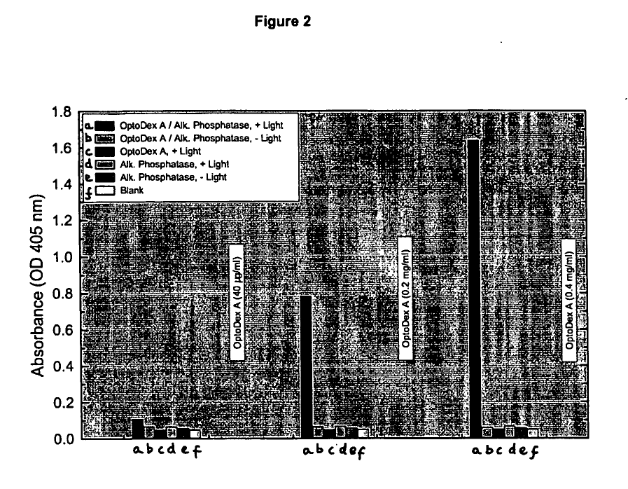

FIG. 2 is a quantitative analysis of linker polymer mediated enzyme immobilized on woven textile showing the light dependence and linker polymer dependence of the process. The enzyme immobilized is alkaline phosphatase; PES corresponds to a polyester control sample;

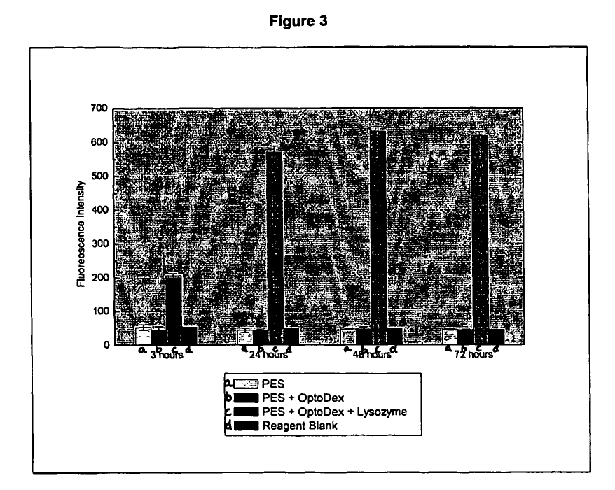

FIG. 3 depicts the linker polymer mediated immobilization of the enzyme lysozyme. The enzymatic activity monitors the disruption of fluorophore labeled bacteria. High fluorescence intensity corresponds to a high lytic activity of lysozyme. PES corresponds to a polyester control sample; and

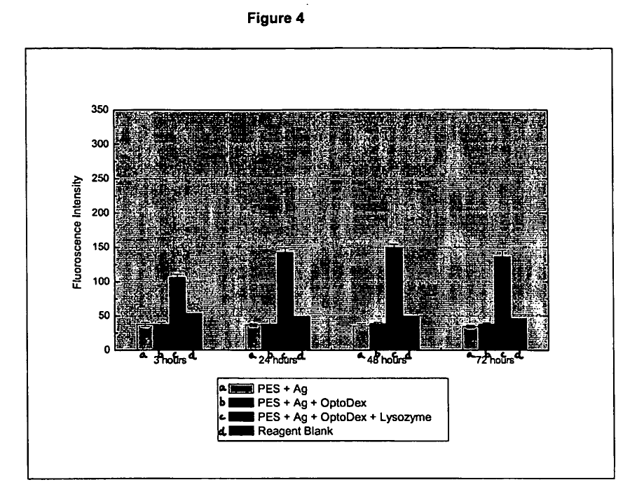

FIG. 4 shows the feasibility of combining two bactericidal agents: metallic silver and lysozyme on textile as tested by the lytic activity. As bactericidal Ag+ ions do not break the cells and metallic silver quenches fluorescence to some extent, the lytic activity of immobilized is not fully detected. PES corresponds to a polyester control sample; Ag refers to treatment of textiles with metallic silver.

The following examples describe procedures and product properties of polyester yarn, textile and textile products. The procedures described are applicable with slight modifications to other natural and synthetic yarns and textile products including blended yarns and textile.

### EXAMPLE 1

Synthesis of Photolinker Polymers: OptoDex A, OptoDex C and Cy3-OptoDex.

OptoDex A was prepared by partial thiocarbamoylation of the amino groups of aminodextran—a 40 kDalton dextran with up to 80 mol amino functions per mol dextran as obtained for instance from Molecular Probes, with 3-(trifluoromethyl)-3-(m-isothiocyanophenyl) diazirine. OptoDex C was synthesized by derivatization of OptoDex A with glutaranhydride. Cy3-OptoDex was prepared by treatment of OptoDex A with the monofunctional N-hydroxysuccinimide ester of Cy3 cyanine dye (a product of Amersham). OptoDex A, OptoDex C and Cy3-OptoDex are thus linker polymers which are multiple substituted with both, the photoactive chemical species and amino functions (OptoDex A), carboxy functions (OptoDex C) or a fluorescent dye Cy3-OptoDex.

### EXAMPLE 2

Textile Pre-treatment and Coating with Photolinker Polymers.

Commercial synthetic polyester yarn shows low water adsorption and wetting properties are not favourable for treatment with aqueous systems. As a consequence of the low water binding capacity, the surfaces did not sufficiently wet to achieve adsorptive binding of the photolinker polymer. Oxygen plasma treatment for 3 min (250 Watt, Oxygen pressure, 250 mτ) resulted in good wetting of polyester textile fabric. Wetting properties of functionalised polyester textile was improved upon treatment of the textile with the photolinker polymer OptoDex A, OptoDex C or Cy3-OptoDex.

In one set of experiments, coating of polyester tissue with the photolinker polymer OptoDex was carried out with non-fluorescent OptoDex A and with the fluorescent OptoDex Cy3 using polyester textile sample pads (2×2 cm) produced by Bischoff-Textil, Switzerland. After oxygen plasma treatment, tissue samples were incubated in aqueous solutions containing either OptoDex A or OptoDex Cy3. The samples were rinsed with water, dried and exposed to light (4 min, 11 mW/ cm²) for photoimmobilization. After photoimmobilization, excess OptoDex was removed by rinsing with phosphate buffered saline (PBS) containing 0.05% Tween 20, pH 7.4, followed by PBS, pH 7.4, (products purchased from Sigma) and water. The samples were then sonicated in deionized water and dried by centrifugation. Tissue samples were then investigated by light microscopy (textile appearance) and fluorescence microscopy (Cy3-OptoDex binding). Treatment of the textile with OptoDex A does not alter the appearance and texture of the sample (FIG. 1A). Post-process dyeing of the fabric is shown in FIG. 1B.

### EXAMPLE 3

Photoimmobilization of Alkaline Phosphatase on Woven Polyester Textile:

a) Optodex A was dissolved with PBS buffer (1:100 diluted) at a final concentration of 0.04 mg/ml, 0.2 mg/ml and 0.4 mg/ml respectively. Tissue samples (woven polyester, 8×9 cm²) were treated with oxygen plasma and dipped in the OptoDex A solution for 1 hour at room temperature. Tissue samples were rinsed with bidistilled water, dried in vacuum for 1 h (5×10⁻² mbar) and stored vacuum packed at −20° C. till used.
b) Photoimmobilization of alkaline phosphatase: Alkaline phosphase was dissolved in PBS (1:100 diluted containing 10% ethanol) and applied to OptoDex A coated tissue samles (1.0 μg/100 μd applied to 1 cm² textile). Identically treated non OptoDex A-coated tissue samples served as controls (8 replicate for each sample). After drying for 3 h in vacuum (1 h at 20 mbar, followed by 2 h at 5×10⁻² mbar), chips were irradiated for 4 min with an Oriel light source (350 nm, 11 mW/cm²). All samples were rinsed with permanent solvent stirring with the following media and incubation times: 3 times 5 min PBS / Tween 20, 0.05%, pH, 7.4, 3 times 5 min PBS, pH 7.4 and 3 times 5 min H₂O.
c) Assay of alkaline phosphatase activity on modified tissue: The enzymatic activity of alkaline phosphatase was determined using the Phosphatase Substrate Kit as purchased from Pierce Chemicals. The enzyme substrate solution was prepared by dissolving one PNPP tablet in 8 ml bidistilled water and 2 ml DEA buffer. Enzyme treated and control tissue samples were placed in individual Falcon plate wells (48 well Falcon plate) and the substrate solution (400 μl/chip) was added and incubated for 30 min at 37° C. The enzymatic reaction was stopped by addition 2 N NaOH (200 μl/chip) and the reaction solution was transferred to a microtiter plate (200 μl/chip/well). For assay quantitation, colour development was measured on an ELISA reader (Spectra max 340) by registrating the absorption at 405 nm.

### EXAMPLE 4

Enzymatic Activity of Lysozyme onto Woven Polyester Textile

a) Optodex A was dissolved with PBS buffer (1:100 diluted) at a final concentration of 0.1 mg/ml. Tissue samples (woven polyester, 8×9 cm²) were treated with oxygen plasma and dipped in the OptoDex A solution for 1 hour at room temperature. Tissue samples were rinsed with bidistilled water, dried in vacuum for 1 h (5×10⁻² mbar) and stored vacuum packed at −20° C. till used.
b) Photoimmobilization of lysozyme: Lysozyme from egg white (Sigma L 6876) was dissolved with PBS (1:100 diluted containing 10% ethanol) and applied to OptoDex A coated tissue samples (6.4 μg / 100 μl, applied to 1 cm² textile). Identically treated non OptoDex A-coated tissue samples served as controls (8 replicate for each sample). After drying for 3 h in vacuum (1 h at 20 mbar, followed by 2 h at 5×10−2 mbar), chips were irradiated for 4 min with an Oriel light source (350 nm, 11 mW/cm2). All samples were rinsed with permanent solvent stirring with the following media and incubation times: 3 times 5 min PBS /Tween 20, 0.05%, pH, 7.4, 3 times 5 min PBS, pH 7.4 and 3 times 5 min H2O.
c) Enzymatic activity of lysozyme on tissue: Enzymatic activity was determined with EnzChek Lysozyme Assay Kit (Molecular Probes). The assay is based on the catalytic property of lysozyme to break cell wall components of certain bacteria. One component of the assay is fluorescent-labelled Micrococcus lysodeikticus bacteria. Upon cell lysis the fluorophores are released and fluorescence can be measured in solution. Lysozyme coated tissue samples were individually placed in Falcon plate wells (48 well plates), the original enzyme substrate solution was diluted by a factor of 40 and applied to the tissue samples (400 μl/chip). After incubation for indicated lengths of time at 37° C. at 80% humidity, substrate solutions were transferred to fluoro-microtiterplate for fluorescent signal measurement (200 μl/well). Signal intensities were registered with a Luminescence Spectrometer LS 50B (λₑₓ=485 nm and λₑₘ=530 nm).

### EXAMPLE 5

Dextranase Catalysed Release of OptoDex Tethered Lysozyme

Photoimmobilization of lysozyme modified polymer samples was carried out as described in the example 4 and surfaces were rinsed with permanent solvent stirring with the following media and incubation times: 3 times 5 min PBS / Tween 20, 0.05%, pH, 7.4. 3 times 5 min PBS, pH 7.4 and 3 times 5 min H₂O. Before measuring the enzymatic activity, OptoDex tethered lysozyme was treated with the enzyme dextranase. Dextranase was dissolved in 0.1 M sodium phosphate buffer pH 6.8 in (10 μg/ml), 60 μl were applied per well and the mixture was incubated during 30 min at 370° C. Total lysozyme activity was determined as described in example 4. The results are summarized in the Table below

Dextranase catalysed release of OptoDex tethered lysozyme

| | Lysozyme activity | | |
|---|---|---|---|
| | (Fluorescence intensity: arbitrary units) | | |
| Lysozyme assay | Without dextranase | With dextranase | |
| incubation time | treatment | treatment | Difference |
| 1 hour | 73 | 79 | 6 |
| 24 hours | 273 | 608 | 335 |
| 48 hours | 399 | 795 | 396 |
| 180 hours | 500 | 812 | 312 |

### EXAMPLE 6

Combined Functionalization of Textile with Metallic Silver and Lysozyme:

a) Method of deposition of metals and dielectrics to a substrate in a vacuum chamber with ionized gases, e.g. argon, and effect of such deposited silver on bacterial proliferation.

Polyester tissue samples (woven polyester, 8×9 cm²) were placed in a vacuum chamber and the textile substrate was evacuated to a pressure of less than 5×10⁻⁵ mbar. A plasma of argon ions is generated by applying a voltage of 400 Volts to a silver target and introduction of argon to a pressure of 5×10⁻³ mbar. Silver was deposited to the substrate for 12 sec. to get a deposit thickness of approx. 20 nm. Bioactivity of such treated textile was investigated by analyzing the cell proliferation of Staphylococcus aureus and Klebsiella pneumoniae after incubation of impregnated textile at 37° C. The table below lists the change in cell count (log) after 24 hours incubation (mean values of 3 experimental series)

Bioactivity of silver treated polyester textile

| | | Staphylococcus | Klebsiella |
|---|---|---|---|
| | | aureus | pneumoniae |
| | Incubation | Change of | Change of |
| Textile | time (hours) | cell counts (log) | cell counts (log) |
| PES | 24 | +3.0 | +2.8 |
| untreated | | | |
| PES, | 24 | −0.5 | −1.2 |
| Silver | | | |
| treated | | | |

b) Lysozyme functionalization of silver treated textile

Silver treated samples as described above were coated with OptoDex A, Optodex A being dissolved in PBS buffer (1:100 diluted) at a final concentration of 0.1 mg/ml. Tissue samples were dipped in the OptoDex A solution for 1 hour at ambient temperature. Tissue samples were rinsed with bidistilled water, dried in vacuum for 1 h (5×10⁻² mbar) and stored vacuum packed at −20° C. till used.

Lysozyme was photoimmobilized by procedures analogous to the description in example 4, paragraph b, and the lysozyme activity was assayed as detailed in paragraph c, example 4. Long-term lytic activity of covalent immobilized lysozyme is retained. Due to quenching of the released fluorescence by the presence of metallic silver, the recorded fluorescence intensities are decreased . The combined treatment of textile with metallic silver and lysozyme results in a functionalized textile that affects bacterial by cell wall lysis (non diffusilbe lysozyme) and by the inhibition of vital bacterial cell function with silver ions.

1. A method of providing a yarn or textile product with a desired property which comprises:
contacting a linker molecule comprising two or more carbene generating groups with a yarn or textile product, and a non-linker molecule having a desired property;
activating the carbene generating groups of the linker molecule to cause covalent attachment of the linker molecule to the yarn or textile product and the non-linker molecule, thereby attaching the non-linker molecule to the yarn or textile product by means of the linker molecule, and providing the yarn or textile product with the property of the non-linker molecule.

2. A method according to claim 1, wherein the non-linker molecule is covalently attached to the yarn or textile product in a single reaction step.

3. (canceled)

4. A method according to claim 1, wherein the non-linker molecule is a solvent, a synthetic or natural chemical, a synthetic or natural dye, a synthetic polymer, a biopolymer, a biomolecule, a biologically active molecule, a synthetic or natural vitamin or hormone, or any combination thereof.

5. A method according to claim 1, wherein the non-linker molecule is an enzyme (such as lysozyme), a growth factor, an anti-microbial agent, an antibiotic, a fungicide, an agent capable of suppressing the proliferation of bacteria or fungi, or any combination thereof.

6-13. (canceled)

14. A method according to claim 1, wherein the carbene is thermochemically or photochemically generated.

15. A method according to claim 1, wherein the linker molecule comprises a natural or synthetic polymer, preferably a biopolymer.

16. A method according to claim 15, wherein the linker molecule comprises a protein, peptide, or polysaccharide.

17. A method according to claim 15, wherein the linker molecule comprises a dextran-based polymer.

18. A method according to claim 1, wherein the linker molecule comprises a cleavage site which is cleaved under predetermined conditions to release the non-linker molecule or functional group from the yarn or textile product.

19. A method according to claim 18, wherein the linker molecule comprises a target for a hydrolytic enzyme to allow enzyme-induced, or biosystem-induced release of the non-linker molecule or functional group.

20. A method according to claim 18, wherein the linker molecule comprises a substrate for an endoglycosidase, or an endopeptidase.

21. A method according to claim 19, wherein the linker molecule is a dextran-based biopolymer which comprises a target for a dextranase.

22-24. (canceled)

25. A method according to claim 1, wherein the yarn or textile product is of natural or synthetic origin, a blend of synthetic yarns, or a blend of natural and synthetic yarns.

26-31. (canceled)

32. A method of covalently attaching a non-linker molecule having a desired property and/or a functional group having a different desired property to a yarn or textile product, thereby providing the yarn or textile product with the desired property or properties, wherein the method comprises use of a linker molecule comprising two or more carbine generating groups.

33. A yarn or textile product covalently attached, by means of a linker molecule, to a non-linker molecule having a desired property, thereby providing the yarn or textile product with the desired property, wherein covalent attachment of the non-linker molecule to the yarn or textile product is the result of reaction of carbene intermediates provided by the linker molecule with the yarn or textile product and the non-inker molecule.

34. A yarn or textile product according to claim 33, wherein covalent attachment of the non-linker molecule to the yarn or textile product is the result of reaction of thermochemically or photochemically generated carbenes provided by the linker molecule.

35-36. (canceled)

37. A yarn or textile product according to claim 33, wherein the non-linker molecule is an enzyme (such as lysozyme), a growth factor, an anti-microbial agent, an antibiotic, a fungicide, an agent capable of suppressing the proliferation of bacteria or fungi, or any combination thereof.

38-51. (canceled)

52. A yarn or textile product according to claim 33, wherein the linker molecule comprises a cleavage site which is cleaved under predetermined conditions to allow release of the non-linker molecule or functional group from the yarn or textile product.

53. A yarn or textile product according to claim 52, wherein the linker molecule comprises a target for a hydrolytic enzyme to allow enzyme-induced, or biosystem-induced release of the non-linker molecule.

54-58. (canceled)

59. A yarn or textile product according to claim 33 which is of natural or synthetic origin, a blend of synthetic yarns, or a blend of natural and synthetic yarns.

60. A composition comprising a yarn or textile product, a linker comprising a dextran-based polymer or a cleavage site which is cleaved under predetermined conditions, and optionally a non-linker molecule as defined in claim 37.
